(19) United States
(12) Patent Application Publication
(10) Pub. No.: US 2006/0253897 A1
(43) Pub. Date: Nov. 9, 2006

(54) Copy-protected application for digital broadcasting system

(75) Inventors: Jonathan G. Foster, Bradford-On-Avon (GB); Immo Benjes, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N. V.

(21) Appl. No.: 10/566,761

(22) PCT Filed: Jul. 28, 2004
(86) PCT No.: PCT/IB04/02573

§ 371 Date: Jan. 31, 2006

(30) Foreign Application Priority Data
Aug. 2, 2003 (GB) 0318198.9

(51) Int. Cl. H04L 9/32; G06F 15/16

(52) U.S. Cl. 726/3

(57) ABSTRACT

A copy-protected application is broadcast to terminals (60) in a digital broadcasting system such as the Multimedia Home Platform (MHP). The application comprises a launcher application (310) and a main application (320). The launcher application (310) causes a terminal to create a server, such as an HTTP server (315) on the terminal (60). An application loader, such as a DVBClassLoader (316), loads the main application into the terminal via the server (315). The main application can be an encrypted application which is decrypted as it passes through the server (315). The launcher application (310) obtains authorization from an external party before proceeding with decryption.

This invention relates to digital broadcasting systems and, in particular, to the delivery of applications to terminals in such systems.

Digital Video Broadcasting (DVB) systems were originally developed to deliver audio and video material. In recent years there has been increasing interest in delivering applications which can be downloaded and executed by terminals. The Digital Video Broadcasting Multimedia Home Platform (DVB-MHP) is a result of efforts to harmonise standards for multimedia set top boxes. It is an open, published, standard for interactive digital television. DVB-MHP, or simply MHP, defines a generic interface between interactive digital applications and the terminals which execute those applications. MHP standards, such as ETSI TS 101 812 V1.3.1, can be viewed at www.etsi.org. Version 1.0.3 of the MHP standard supports freely downloadable applications called ‘Xlets’. Digital Video Broadcasting Globally Executable MHP (DVB-GEM), set out in ETSI TS 102 819, also supports downloadable applications.

Some broadcasters choose to encrypt an entire broadcast stream using a conditional access (CA) system so as to restrict access to content, such as broadcast channels or applications, only to those who have subscribed to their services. While this has proved to offer a high degree of protection to piracy of the content, it requires dedicated descrambling hardware at the user's set-top box. Viewers need either a special set-top box that includes the CA system, or a set-top box with a slot which conforms to the DVB Common Interface (DVB-Cl) and a Cl module containing the CA system. Viewers also need a smartcard that identifies them, and the broadcaster needs to keep a central database of authorized smartcards. Many broadcasters use their own bespoke encryption algorithms for the CA system. Realistically, only broadcasters who charge a monthly subscription fee can afford to set up the infrastructure required for a CA system. In view of the above, many broadcasters have chosen not to encrypt the entire transport stream in this manner.

There is interest in delivering pay-per-use applications, such as games, to user terminals as this can generate additional revenue for a broadcaster. However, the current MHP standards do not include support for encrypted applications. Without the ability to encrypt applications, any applications delivered to user terminals are vulnerable to piracy. Indeed, it is already possible to obtain equipment which can ‘grab’ the entire contents of a file system which is broadcast as part of the broadcast stream, including the code for any applications, and save this to a hard disk.

MHP is based around a Java™ virtual machine, with applications written in Java and then compiled into Java bytecode. It would be desirable to encrypt the Java™ class files that are transmitted in the broadcast stream. Ways of encrypting Java class files have been discussed in the articles “How do I store a Java App in a Self-Executing Encrypted File?”, Dave Angel and Andy Wilson, Dr, Dobb's Journal, February 1999 and “Encrypted Class Files” by Greg Travis, located at: http://www.webtechniques.com/archives/2001/08/travis/. A key requirement of the published methods is the use of a Java ‘ClassLoader’. However, all current versions of the MHP standard specifically forbid the creation of a normal ClassLoader or any subclass (i.e. modified version of) the ClassLoader class. Thus, it is impossible to create a custom ClassLoader which decrypts the classes in the manner taught by these articles.

The present invention seeks to provide a way of delivering encrypted applications to terminals.

Accordingly, a first aspect of the present invention provides a method of downloading an application at a terminal in a digital broadcasting system, comprising the steps of:

receiving a launcher application;

starting the launcher application;

creating a server on the terminal; and

generating an application loader for loading a main application into the terminal via the server.

Preferably, the main application is an encrypted application and the launcher application is arranged to decrypt the main application as it is loaded via the server.

The creation of a server on the terminal allows the decrypted application to be safely stored within the terminal, minimising exposure to hackers. The newly created server on the terminal is provided with a port and the address of the port is supplied to the application loader. Typically, the address will be localhost or 127.0.0.1.

Where the terminal is an MHP terminal, this allows an application loader of the type ‘DVBClassLoader’ to be used, which expects to load classes from a uniform resource locator (URL). The server is allocated a URL and the URL is supplied to the DVBClassLoader function.

It should be noted that the launcher application and main application can be received together (i.e. sequentially, one directly after the other), or at separate times. Also, the launcher application and main application can be sent via the same delivery channel or via separate delivery channels. As an example, the launcher application and main application can both be received via a broadcast channel; while in another example the launcher application is received via a broadcast channel while the main application is received via an internet delivery channel.

Preferably, the server is arranged to only respond to connection requests which originate inside the terminal to ensure the application remains secure.

Preferably, the method further comprises contacting an external party to obtain authorization before decrypting the main application. It is preferred that a decryption key is received from the external party in response to the user being authorized. However, in a simpler variation, the decryption key can be supplied with the launcher application.

The terminal is most likely to take the form of a set-top box (STB) but it can take other forms, such as a multimedia personal computer (PC) or a television set which incorporates the functionality of the set-top box.

The invention is particularly applicable to all current versions of the Multimedia Home Platform (MHP), although it has wider application to digital broadcasting systems. These include:
DVB-GEM (TS 102 819)=Globally Executable MHP−this is a subset of MHP which is not dependent on DVB-SI;
OCAP=OpenCable Application Platform, the new US cable standard based on GEM;
ATSC-DASE=Advanced Television Systems Committee (ATSC) Digital TV Applications Software Environment (DASE), the US terrestrial standard, currently being rewritten based on GEM; and,
ARIB-AE=ARIB (a Japanese TV standards body) standard B-23 “Application Execution Engine Platform for Digital Broadcasting” (ARIB-AE), based on GEM.

Further aspects of the invention provide a method of creating an application for transmission to terminals in a digital broadcasting system, authoring software for creating such an application, a method of transmitting an application to a terminal in a digital broadcasting system, software for an application for transmission to a terminal in a digital broadcasting system, and a signal for transmission in a digital broadcasting system.

Embodiments of the present invention will now be described, by way of example only, with reference to the accompanying drawings, in which:—

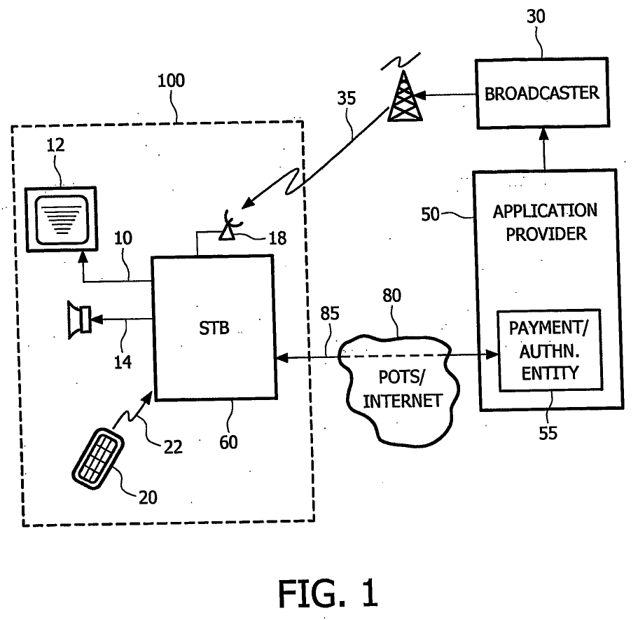

FIG. 1 shows a digital video broadcast (DVB) system embodying the invention;

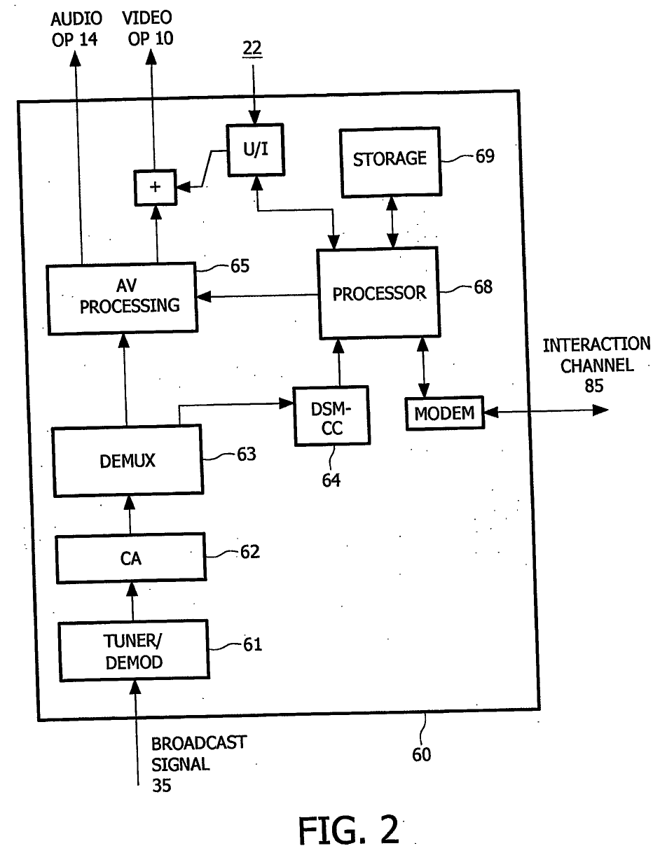

FIG. 2 shows the functional blocks within a subscriber terminal for use in the system of FIG. 1;

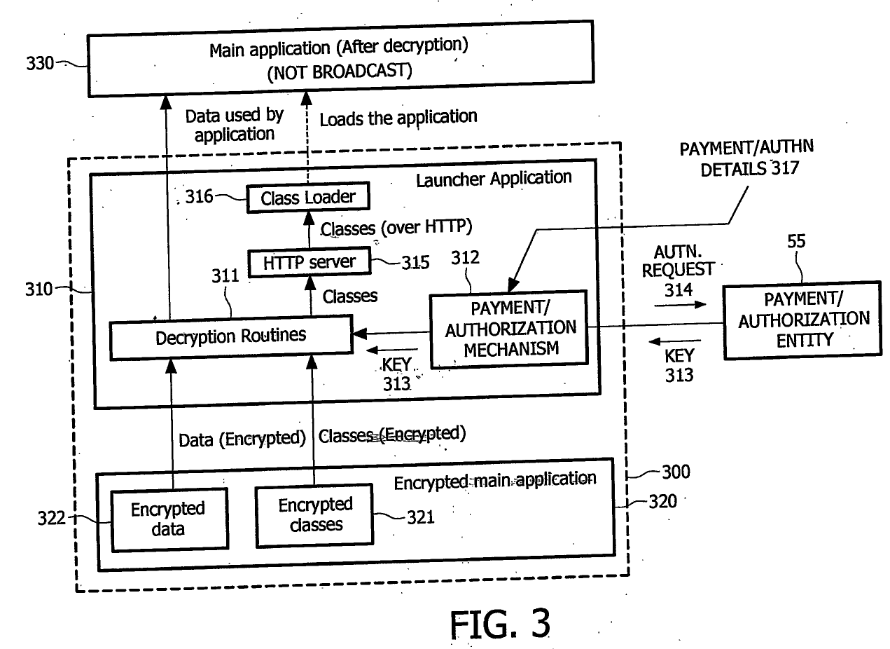

FIG. 3 shows the components of an encrypted application in accordance with the invention;

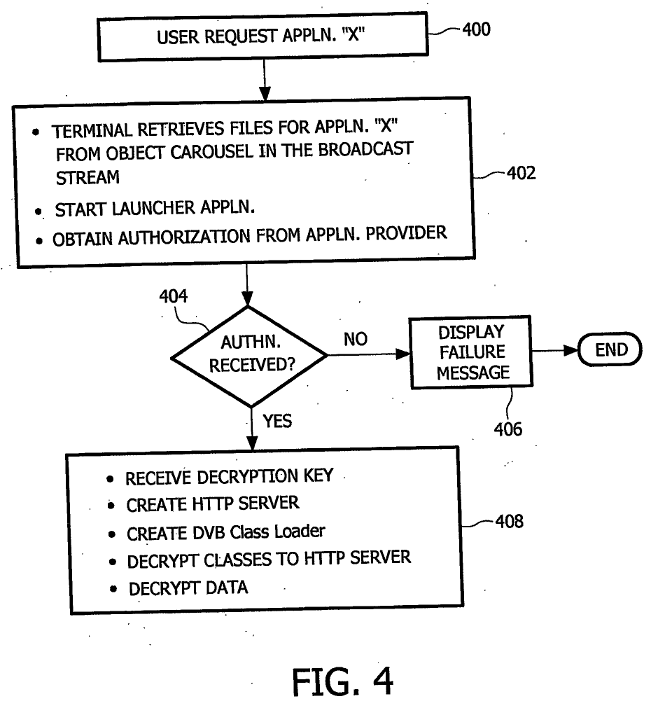

FIG. 4 shows a flow chart for processing an encrypted application.

FIG. 1 shows an overall digital video broadcasting system for delivering applications to a terminal. Content is generated by a broadcaster 30 and converted into a suitable format for transmission, via a broadcast channel 35, to user premises 100. One such premises 100 is shown. Typically, the broadcast channel 35 is delivered via a satellite although it can be delivered by a terrestrial transmission network, by a cable distribution network, or by a data network such as the Internet, and the method of delivery is not important to the invention. A terminal (STB) 60 at a user premises receives the broadcast stream, which in this example is via an antenna 18. The broadcast stream delivered via the broadcast channel 35 comprises audio and video content as well as data for supporting various services and applications. In the DVB-MHP specification, data for applications is broadcast as part of a Digital Storage Media—Command and Control (DSM-CC) Object Carousel. This is a repetitively broadcast file system containing the data files for various applications. The format of the broadcast channel for the DVB-MHP system, including the DSM-CC, is set out in ISO/IEC 13818-6, to which the skilled reader is directed for further information.

Applications can be created by the broadcaster 30 or by independent application providers 50 who supply the required files to the broadcaster 30 for insertion in the DSM-CC. Examples of applications include electronic programme guides (EPG), games, quizzes, instructional guides and e-commerce applications such as home banking.

The set top box 60 is also provided with a modem to support a return (or interaction) channel 85 to allow the set top box 60 to send data to, and receive data from, external parties. The interaction channel typically uses a conventional telephony network such as POTS. The interaction channel 85 can take the form of: a dial-up (POTS) connection directly to an application provider 50, a connection to a gateway of a data network such as the internet, with the connection between the gateway and the application provider 50 being carried across the data network, a combination of a cable back-channel and a connection across a data network (internet) to the application provider, an ADSL or other broadband internet connection, satellite uplink or ISDN line.

Set-top box 60 also includes a user interface with a remote control 20 or keyboard for receiving user inputs and a graphical output which can be overlaid upon the video signal 10 which is fed to television display 12.

An MHP terminal is built around a Java™ Virtual Machine (JVM) and applications are written in Java. The use of Java has the advantage that applications can be written in a common format, with the virtual machine in each type of terminal converting the Java bytecode into a form which is compatible with the particular hardware and software resident on that terminal.

FIG. 2 shows the functional blocks within a typical MHP terminal 60. In a known manner, terminal 60 includes a front end for processing a received broadcast signal 35. This includes a tuner 61 and demodulator for selecting and demodulating a required channel and an optional conditional access unit 62 for descrambling the signal. The resulting digital data stream is demultiplexed 63 into data streams representing audio and video data (typically in MPEG-2 format) and data for applications in the form of the repetitively broadcast DSM-CC Object Carousel 64. The audio and video data can then be further processed 65 to derive suitable output signals 12, 14 for presentation to a user. Once downloaded from the broadcast stream, the application (or several applications) will reside on memory 69 in the terminal and will be executed by microprocessor 68 in the terminal. An application may receive user inputs 22, generate audio and video outputs, and access the interaction channel 85. Control software for operating the microprocessor 68 also resides on a memory device. It should be noted that FIG. 2 shows a terminal which is intended to receive signals via a broadcast delivery channel. In other embodiments of the terminal, which are intended to interface with non-broadcast delivery channels, the tuner/demodulator 61 is replaced by a network interface appropriate to the delivery channel. This can be an Internet Protocol (IP)-based delivery channel.

FIGS. 3 and 4 show the process for downloading an encrypted application from the broadcast stream. FIG. 3 shows the components of the transmitted application while FIG. 4 shows a flow chart of the process performed by a terminal 60 to download and run an application. At step 400, a user requests that an application “X” is downloaded. The request can be made in a conventional manner, such as by a user navigating through on-screen menus and pressing keys on remote control 20. The requested application is broadcast in two parts, shown collectively as block 300:

a ‘launcher’ or ‘loader’ Xlet 310 which is broadcast in an unencrypted format;

the main application 320, which is broadcast in an encrypted format. The main application 320 includes classes 321 and data 322, both of which are encrypted.

The encrypted main application can be transmitted via the DSM-CC Data Carousel, DSM-CC MPE (IP Multicast encapsulation), via Data Piping or even via the Internet.

The launcher application 310 and encrypted main application 320 can be transmitted together, or separately. If transmitted separately, they can either both be sent via the same transport stream, such as the DSM-CC, or via different transport streams (one broadcast, one sent via the internet). Thus, using this invention, it is possible to send encrypted classes over the Internet and then decrypt them at the terminal.

At step 402 the terminal retrieves the necessary files for application X from the object carousel 64 in the broadcast stream. The launcher application 310 is then started. The launcher application 310 contacts the application provider 50 over the interaction channel 85, sending an authorization request 314. The purpose of contacting the application provider 50 is to ensure that the user is authorized to run the application. This step may also involve collecting payment from the user before authorizing them to use the application. If the user is authorized, they receive a decryption key 313 from the application provider 50 over the interaction channel 85. If the user is not authorized, a message is returned to the terminal 60 and a message is displayed to the user notifying them of this, at step 406. Nothing further happens and the main application 320 is not decrypted. There are various ways in which the authorization can be achieved. Some possible ways of obtaining authorization are:

the launcher application 310 prompts the user for credit card details. Upon receiving the credit card details 317, the launcher application 310 contacts the payment authorization entity 55 at application provider 50 and passes the credit card details. If payment is accepted, a decryption key 313 is returned from the application provider 50 to the terminal 60 over the interaction channel 85;

the launcher application 310 dials a premium-rate telephone number operated by the application provider 50. The call is maintained until the cost of the phone call incurred by the user of the terminal 60 equals the price of the application. At this point the application provider 50 sends a decryption key 313 to the launcher application 310 and the call is terminated;

the launcher application 310 prompts the user for a subscription or club membership number, possibly with a password or PIN. The launcher application then contacts 314 the application provider 50 and provides this information. If the user is authorized, a decryption key 313 is sent from the application provider 50 to the terminal 60;

the launcher application 310 takes payment from a smartcard (e.g. German GeldKarte) which is inserted into a card reader on terminal 60 and then contacts the application provider 50 to obtain a decryption key.

It will be appreciated that any other means can be used where the launcher application 310 contacts the application provider 50 to obtain a decryption key 313, preferably after paying the application provider 50 in some way.

Referring again to FIG. 4, at step 408 the launcher application 310 now needs to decrypt and run the MHP application 320. In order to overcome the restriction on creating a ClassLoader, the launcher application 310 includes code to create a small HTTP server 315 on the terminal 60. Once authorization is received, the launcher application 310 starts this HTTP server 315. The HTTP server 315 will create a java.net.ServerSocket class with a specified port. The launcher application 310 then creates a DVBClassLoader 316. DVBClassLoader is a part of the MHP standard and can only load classes from a URL, e.g. from a HTTP server. The launcher application 310 passes the URL of the HTTP server 315 that it has just created to the DVBClassLoader 316. Once the DVBClassLoader connects to this port a Socket (java.net.Socket) connection is created. This connection can be used for bidirectional communication. The launcher application 310 can then start the main application 330 inside the DVBClassLoader 316. Decrypting the main application 320, and any data it needs, can be done with any standard decryption algorithm. Examples of these include Data Encryption Standard (DES), Triple Data Encryption Standard (3DES) and Advanced Encryption Standard (AES). The decryption algorithm may need to be broadcast with the application. The preferred manner of decryption is decryption on-demand, i.e. when an application needs to load a class, a request is sent from the DVBClassLoader to the HTTP server for the data for that class. The encrypted class files are downloaded from the DSM-CC, decrypted and then passed to the HTTP server 315 from where they are extracted. This reduces memory usage because the decrypted class files are only in memory for a brief time, and there is likely to be only a small number of requests being processed at any point in time.

For security, the HTTP server 315 rejects any connections that do not originate from within the MHP terminal. Ideally, the HTTP server 315 should be listening only on the ‘localhost’ IP address, so normal TCP/IP semantics will block external connections. This means that the decrypted classes do not leave the MHP terminal 60. Devices supporting TCP/IP may have multiple network interfaces. Typically each network interface corresponds to a single physical network connection. However, all TCP/IP devices have a special virtual network interface, called the ‘loopback’ interface. This is only accessible from within the device, it is not possible to access it remotely. When a TCP/IP server socket is created, it will default to being accessible from all network interfaces. However, it is possible to limit or ‘bind’ it to a single network interface. Hence, if the server is bound to the loopback interface (with IP address 127.0.0.1), then it will not be accessible from outside the STB. The HTTP server exists for the lifetime of the encrypted application.

For additional security, the code of both the launcher application 310 and the main application 320 should be obfuscated, to make it more difficult for them to be reverse engineered. This means that the code is processed so that descriptive labels are removed or renamed to less descriptive labels. Thus, even if a hacker were to decrypt the application, they would find it more difficult to modify operation of the application. The use of shorter, non-descriptive labels also helps to reduce the size of the code.

Data used by the application 320 is decrypted using the same key 313, but does not need to be sent through the HTTP server 315. Instead, the decrypted data passes directly to the main application 330.

In the above description, the encrypted data 322 used by the main application is decrypted and then passed directly to the main application 330. As an alternative, the data could be passed to the HTTP server 315.

The server 315 need not be a HTTP server, but could be a server for any protocol supported by the MHP terminal, including FTP.

In the above embodiment the authorization entity 55 is shown as being part of the application provider 50. This need not be the case. Authorization entity 55 can be physically separate from the application provider and perform the authorization function on behalf of the application provider 50.

In the above embodiment the decryption key 313 is supplied by the application provider 50 in response to payment by the user, or suitable authorization. However, this technique may be used merely to make an application harder to reverse engineer. In this case, the decryption key 313 can be supplied as part of the launcher application 310. Classes would still be decrypted into a HTTP server 315 and would remain inside the terminal 60.

The invention is not limited to the embodiments described herein, which may be modified or varied without departing from the scope of the invention.

1. A method of downloading an application at a terminal (60) in a digital broadcasting system, comprising the steps of:
receiving a launcher application (310);
starting the launcher application (310);
creating a server (315) on the terminal; and
generating an application loader (316) for loading a main application into the terminal via the server (315).

2. A method according to claim 1 wherein the main application is an encrypted application.

3. A method according to claim 2 wherein the launcher application is arranged to decrypt the main application (320) as it is loaded via the server (315).

4. A method according to claim 3 further comprising the step of contacting (314) an external party (55) to obtain authorization before decrypting the main application.

5. A method according to claim 4 further comprising receiving a decryption key (313) from the external party in response to the user being authorized.

6. A method according to claim 4 further comprising the step of collecting payment details (317) from a user of the terminal.

7. A method according to claim 4 further comprising the step of collecting payment from a user of the terminal.

8. A method according to claim 1 wherein the main application (320) comprises classes (321) and data (322) and wherein the application loader is arranged to load only the classes via the server (315).

9. A method according to claim 1 wherein the server (315) is arranged to only respond to connection requests which originate inside the terminal (60).

10. A method according to claim 1 wherein the server (315) is a HTTP server.

11. A method according to claim 1 wherein the main application is received via a different delivery channel to that used to receive the launcher application.

12. A method according to claim 1 wherein the digital broadcasting system is the Multimedia Home Platform (MHP).

13. A method according to claim 1 wherein the terminal is compatible with Multimedia Home Platform (MHP).

14. A method of creating an application for transmission to terminals in a digital broadcasting system, the method comprising creating a launcher application (310) and a main application (320), the launcher application (310) being arranged to create a server (315) on the terminal to which it is sent and to generate an application loader (316) for loading the main application into the terminal via the server (315).

15. A method according to claim 14 wherein the main application is an encrypted application.

16. A method according to claim 15 wherein the launcher application is arranged to decrypt the main application as it is loaded via the server (315).

17. A method according to claim 16 wherein the launcher application is arranged to contact (314) an external party (55) to obtain authorization before decrypting the main application.

18. A method according to claim 17 wherein the launcher application is arranged to receive a decryption key (313) from the external party in response to the user being authorized.

19. A method according to claim 17 wherein the launcher application further comprises means for collecting payment details (317) from a user of the terminal.

20. A method according to claim 17 wherein the launcher application is arranged to collect payment from a user of the terminal.

21. A method according to claim 14 wherein the main application (320) comprises classes (321) and data (322) and wherein the application loader is arranged to load only the classes via the server (315).

22. A method according to claim 14 wherein the server (315) is arranged to only respond to connection requests which originate inside the terminal (60).

23. A method according to claim 14 wherein the server (315) is a HTTP server.

24. Authoring software for creating an application, the authoring software comprising code for performing the method according to claim 14.

25. A method of transmitting an application to a terminal in a digital broadcasting system, the method comprising transmitting a launcher application (310) and a main application (320) to the terminal, the launcher application (310) being arranged to create a server (315) on the terminal to which it is sent and to generate an application loader (316) for loading the decrypted main application into the terminal via the server (315).

26. Software for an application for transmission to a terminal in a digital broadcasting system, comprising a launcher application (310) and a main application (320), the software comprising code which, when executed by a processor in the terminal (60), causes the processor to perform the steps of:
creating a server (315) on the terminal; and,
generating an application loader (316) for loading the main application into the terminal via the server (315).

27. A signal for transmission in a digital broadcasting system, the signal embodying software according to claim 26.

28. A method of downloading an application, method of creating an application, software or signal substantially as described herein with reference to and as shown in the accompanying drawings.
